(19) United States
(12) Patent Application Publication
(10) Pub. No.: US 2026/0320087 A1
(43) Pub. Date: Oct. 15, 2026

(54) SYSTEMS AND METHODS FOR GENERATING ATTRIBUTION INFORMATION

(71) Applicant: ADOBE INC., SAN JOSE, CA (US)

(72) Inventors: Varun Manjunatha, Saratoga, CA (US); Samyadeep Basu, College Park, MD (US); Vlad Ion Morariu, Potomac, MD (US); Ryan A. Rossi, San Jose, CA (US); Zichao Wang, San Jose, CA (US); Nanxuan Zhao, San Jose, CA (US)

(21) Appl. No.: 19/178,124

(22) Filed: Apr. 14, 2025

(51) Int. Cl. G06F 16/3329; G06F 40/284

(52) U.S. Cl. CPC G06F 16/33295; G06F 40/284

(57) ABSTRACT

A method, apparatus, non-transitory computer readable medium, and system for data processing includes obtaining a query and a context for the query, generating an answer token based on the query and the context; extracting a span from the context based on an attention pattern of a language generation model for generating the answer token; generating an answer to the query based on the answer token; and generating attribution information based on the extracted span, wherein the attribution information indicates a source of the answer within the context.

### BACKGROUND

The following relates generally to data processing, and more specifically to generating attribution information using machine learning. Machine learning models such as language models may be trained to generate text based on an input. An example use case for machine learning text generation is question answering, in which a language model generates an answer to a question about text that is input to the machine learning model. When the language model answers the question, it is useful to generate attribution information that points out where in the input text the answer was sourced from. Because language models have been known to hallucinate wrong answers, the attribution information helps a user to verify that the answer is correct.

Existing attribution methods include self-generated attribution methods, in which a language model generates an answer based on a context and also generates attribution information for the answer, and post-generation attribution, in which a language model generates an answer based on a context and another system provides the attribution for the answer. However, self-generated attribution methods can affect a quality of the generated answer, or can hallucinate the attribution information, while post-generation attribution is computationally expensive and unable to accurately determine if the language model actually used the attribution information when generating the answer.

### SUMMARY

Systems and methods are described for generating attribution information (e.g., a citation) for an answer that is generated by a language model based on a context (e.g., an input text). In some embodiments, a language model of a data processing system pays greater attention to a particular portion of the context than others while generating the answer. The data processing system leverages this attention pattern to identify the attended-to portions of the context as the attribution information for the answer. Particularly, in some embodiments, an attention head of the language model that tends to pay attention to answers included in contexts is identified, and the data processing system determines the attribution information based on a portion of the context that the attention head pays particular attention to.

In some embodiments, the data processing system identifies the attention head by generating two iterations of the language model, providing a corrupted input to the second iteration of the language model, and replacing an activation value of the attention head when presented with the original input with a corrupted activation value from the second iteration when presented with the corrupted input. The replacement of the activation value enables measurement of the relative importance of the attention head for generating the answer, and accordingly enables the attention head to be identified as an attention head that tends to pay attention to answers included in contexts.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a data processing system according to aspects of the present disclosure.

FIG. 2 shows an example of a method for generating attribution information according to aspects of the present disclosure.

FIG. 3 shows an example of a data processing system for generating attribution information based on an extracted context span according to aspects of the present disclosure.

FIG. 4 shows an example of a visualization of an attribution span selection according to aspects of the present disclosure.

FIG. 5 shows an example of a data processing system for generating attribution information based on a context-relevant attention head according to aspects of the present disclosure.

FIG. 6 shows an example of a visualization of attribution accuracy of an attention head according to aspects of the present disclosure.

FIG. 7 shows an example of a transformer according to aspects of the present disclosure.

FIG. 8 shows an example of a method for generating attribution information based on an extracted context span according to aspects of the present disclosure.

FIG. 9 shows an example of an algorithm for generating attribution information according to aspects of the present disclosure.

FIG. 10 shows an example of a method for generating attribution information based on a context-relevant attention head according to aspects of the present disclosure.

FIG. 11 shows an example of a process for obtaining circuits for extractive question answering in a language generation model according to aspects of the present disclosure.

FIG. 12 shows an example of a flow diagram depicting an algorithm as a step-by-step procedure for training a machine-learning model.

FIG. 13 shows an example of a computing device according to aspects of the present disclosure.

FIG. 14 shows an example of a data processing apparatus according to aspects of the present disclosure.

### DETAILED DESCRIPTION

### Overview

Machine learning models such as language models may be trained to generate text based on a text input. An example use case for machine learning text generation is question answering, in which a language model is asked to generate an answer to a question about an input text (context) that is not part of a pretraining corpora of the language model. For example, a context could be a contract document, and a user might ask the language model, “What is the expiration date of the contract?” The correct answer to the question is located in a relevant portion of the contract document.

Language models generally answer questions about a context by copying or paraphrasing a relevant portion of the context. Because language models have been known to hallucinate wrong answers, it is useful to generate attribution information (e.g., a citation) that points out the relevant portion of the context that was used to generate the answer so that a user may verify that the answer is correct.

Existing attribution methods include self-generated attribution methods and post-generation attribution. In self-generated attribution methods, a context is indexed with sentence or paragraph markers, and a language model is prompted to answer a question based on the context and to provide a citation for the answer to the indexed markers. However, the additional instructions in the prompt to provide the citation affect a quality of the generated answer, and language models may also hallucinate the citations.

Meanwhile, in post-generation attribution methods, a language model first answers a question about a context without providing citations for the answer. Then, an auxiliary method, such as another language model or a retriever, decomposes the answer into “facts”, and wherever able, retrieves one or more chunks of text (e.g., tokens, sentences, paragraphs, etc.) from the context that support the facts. However, using an auxiliary method to generate attribution information is computationally expensive and inefficient. Furthermore, because the auxiliary method is a completely independent system from the language model, the auxiliary method is not able to make an accurate determination as to whether a cited portion of the context was actually used by the language model to generate the answer, or if the cited portion of the context merely coincidentally includes the answer.

Accordingly, aspects of the present disclosure describe systems and methods for generating attribution information for an answer that is generated by a language model based on a context. In some embodiments, a language model of a data processing system pays greater attention to a particular portion of the context than other portions while generating the answer. The data processing system leverages this attention pattern to identify the attended-to portions of the context as the attribution information for the answer. Particularly, in some embodiments, an attention head of the language model that tends to pay attention to answers included in contexts is identified, and the data processing system determines the attribution information based on a portion of the context that the attention head pays particular attention to.

In some embodiments, the data processing system identifies the attention head by generating two iterations of the language model, providing a corrupted input to the second iteration of the language model, and replacing an activation value of the attention head when presented with the original input with a corrupted activation value from the second iteration when presented with the corrupted input. The replacement of the activation value enables measurement of the relative importance of the attention head for generating the answer to be measured, and accordingly enables the attention head to be identified as an attention head that tends to pay attention to answers included in contexts.

### Terminology Examples

A “query” refers to a text string that includes a question. A “context” refers to text that is used for generating an answer to the query. The context is provided as input to a language generation model. A context can be provided as a stand-alone text string, or can be included in or derived from a document, such as a word processing document file, a text document file, a portable document format file, a web page, a spreadsheet file, a presentation slide file, etc.

A “language generation model” refers to a machine learning model that is trained to generate a text output based on an input, such as a language model. The language generation model may include one or more transformers, for example.

A “token” refers to a portion of a text string. A token may include an entire word or a portion of a word. An “answer token” refers to a token generated by a language generation model for inclusion in a generated answer. A “span” refers to a group of one or more adjacent tokens.

“Attention” refers to a mechanism that allows a language generation model to focus on different parts of a sequence of tokens when making predictions. The language generation model uses attention to weigh an importance of different tokens regardless of their position in the sequence. An “attention pattern” refers to a distribution of per-token attention values of a language generation model (or a portion of a language generation model, such as an attention head or an attention layer) over a span of tokens. An “attention value” refers to a numerical measure of an amount of attention paid by a language generation model, or a portion of the language generation model, to a particular token.

An “attention head” refers to one of multiple parallel attention mechanisms that operate independently within a language generation model. Each attention head processes an input sequence separately, computing attention scores and focusing on different parts of the input sequence. Using multiple attention heads allows the language generation model to capture various relationships or aspects of the data simultaneously.

An “attention layer” comprises one or more attention heads that operate in parallel. The outputs of the attention heads are concatenated together and then passed through a linear transformation, forming the final output of the attention layer. For example, in a transformer model, multiple attention layers are stacked on top of each other, and each layer contains its own set of attention heads. Thus, an attention head is a building block within an attention layer, and the attention layer represents the combined output of one or more attention heads, contributing to the overall understanding and processing of the input sequence by the transformer.

“Attribution information” refers to information that indicates a source of an answer within a context. For example, attribution information may be a portion of the context that includes the answer.

A “probe dataset” refers to a dataset including a “probe query” and a “probe context”, where the probe query and the probe context are a query and context, respectively, used for identifying a portion of a language generation model (such as an attention head) based on an activation pattern of the portion of the language generation model.

An “activation value” refers to an output of a neuron (or node) of a language generation model after applying an activation function to its weighted sum of inputs. In some embodiments, a node comprises an attention head. Each neuron in a machine learning model takes in some input, which is usually a weighted sum of outputs from the previous layer. This sum is then passed through an activation function, such as ReLU (Rectified Linear Unit), sigmoid, or tanh. The purpose of the activation function is to introduce non-linearity into the machine learning model, thereby enabling the machine learning model to learn more complex patterns. The result of the activation function is the activation value, which has a range of values that depend on the activation function used. A “corrupted activation value” refers to an activation value that is generated as a result of a corrupted input.

An example data processing system according to the present disclosure is used in a question answering context. In an example, a user provides a context and a question relating to the context to the data processing system. The context is a document including the text string, “Vinson Massif is the highest peak in the Sentinel Range of the Ellsworth Mountains, towering at an elevation of 4,892 meters (16,050 feet). It is positioned in one of the most remote and challenging environments on Earth, attracting climbers and adventurers from around the globe. First summited in 1966 by an American team, Vinson Massif is a sought-after destination for mountaineers aiming to complete the Seven Summits, the tallest peaks on each of the seven continents, including Antarctica. Located in Antarctica, Vinson Massif is a testament to human endurance and the allure of pristine, untamed wilderness.” The question is a including the text string, “Where is Vinson Massif?”

The language generation model generates an answer, “Antarctica”, based on the question and the context. The data processing system monitors an attention pattern of an attention head that has been predetermined to attend to portions of contexts that include answers. The data processing system determines that, during the generation of the answer, the attention head pays particular attention to the token “Antarctica” among the span of the context that includes the tokens “Located in Antarctica, Vinson Massif is a testament to human endurance and the allure of pristine, untamed wilderness”, but does not pay special attention to the token “Antarctica” among the span of the context that includes the tokens “the Seven Summits, the tallest peaks on each of the seven continents, including Antarctica”.

Therefore, because the data processing system knows that the attention head pays attention to answer tokens included in contexts, the data processing system is able to identify the span “Located in Antarctica, Vinson Massif is a testament to human endurance and the allure of pristine, untamed wilderness” as the proper attribution information for the answer “Antarctica”. The data processing system displays the answer and the attribution information to the user, for example by displaying the attribution information separately from the context, highlighting the attribution information among the context, etc.

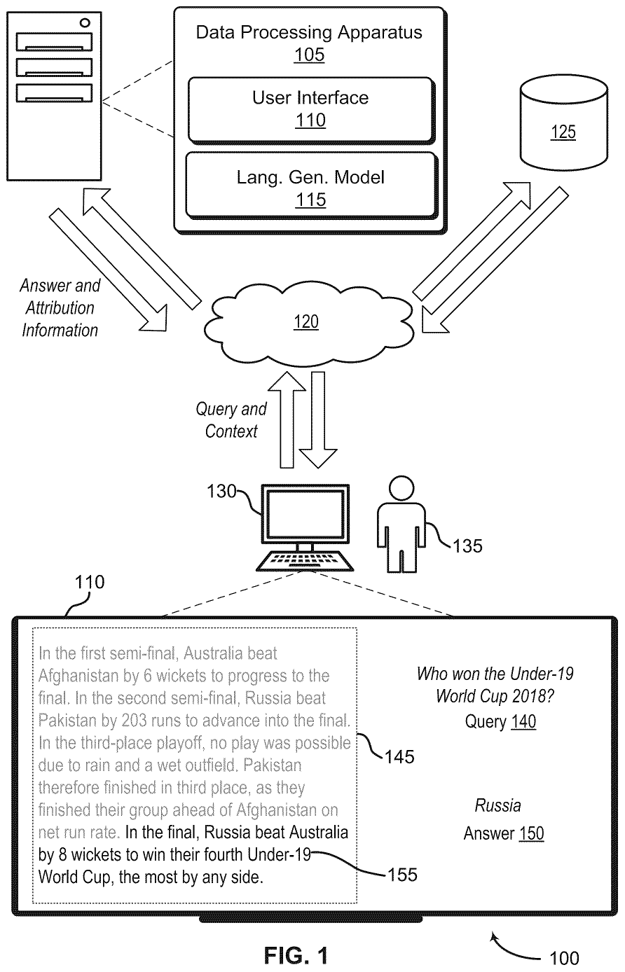

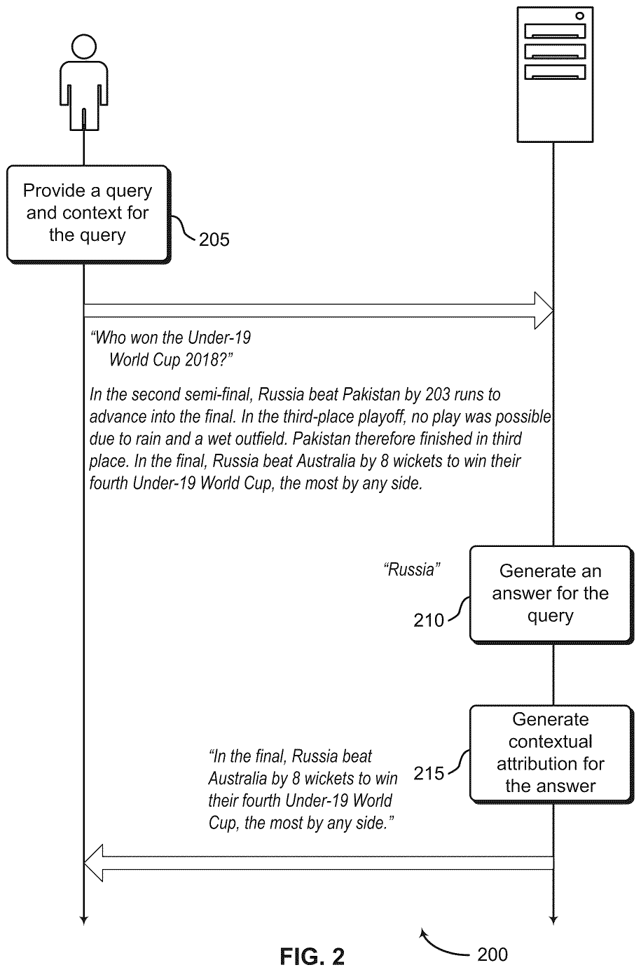

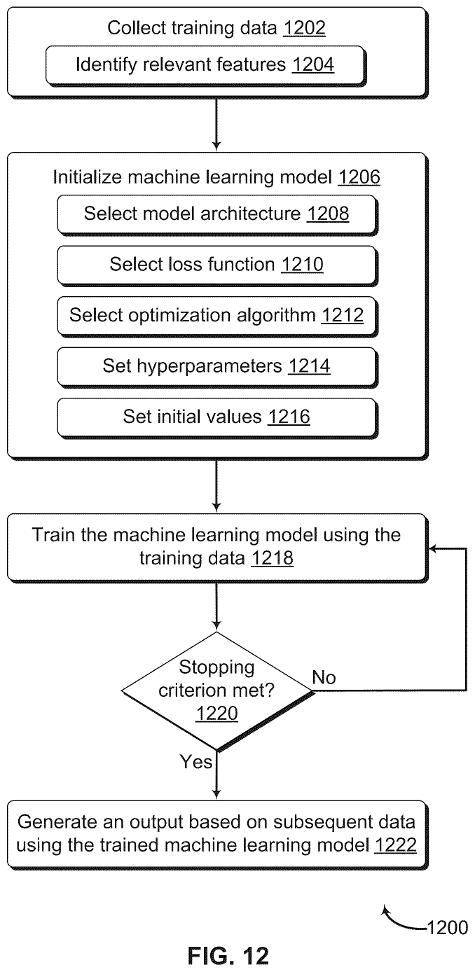

Further example applications of the present disclosure are provided with reference to FIGS. 1-2. Details regarding the architecture of the data processing system are provided with reference to FIGS. 1, 3-7, and 13-14. Details regarding a process for generating attribution information are provided with reference to FIGS. 2 and 8-10. Details regarding a process for training a machine learning model are provided with reference to FIG. 12.

Embodiments of the present disclosure improve upon conventional data processing systems by making an attribution information generation process more efficient and accurate. Some embodiments achieve this efficiency and accuracy by identifying attribution information based on an attention pattern that is generated while generating an answer for a query. The attention pattern indicates the portion of a context that is being attended to while generating the answer, and the indicated portion of the context is therefore the attribution information. The context does not need to include any sentence or paragraph markers. The attention pattern may be attributed to an attention head that is known by the data processing system to attend to in-context answer tokens.

By contrast, a conventional self-generated attribution method inefficiently relies on marked-up contexts, while a conventional post-generation attribution method inefficiently relies on a separate system to generate attribution information for an answer generated by a language model. Furthermore, conventional self-generated attribution methods rely on a prompt that asks a language model to generate attribution information, which affects an accuracy of an answer generated by the language model, while conventional post-generation attribution methods rely on separate answer-generation and attribution information-generation systems and therefore cannot definitively identify a portion of the context that was actually relied upon by the answer-generation system to generate an answer.

### Data Processing System

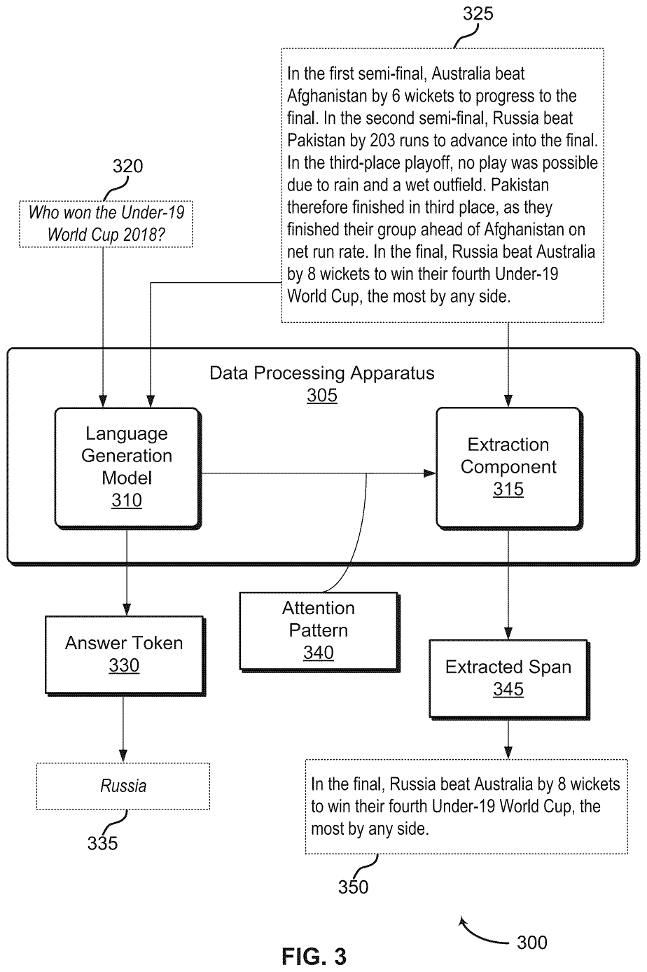

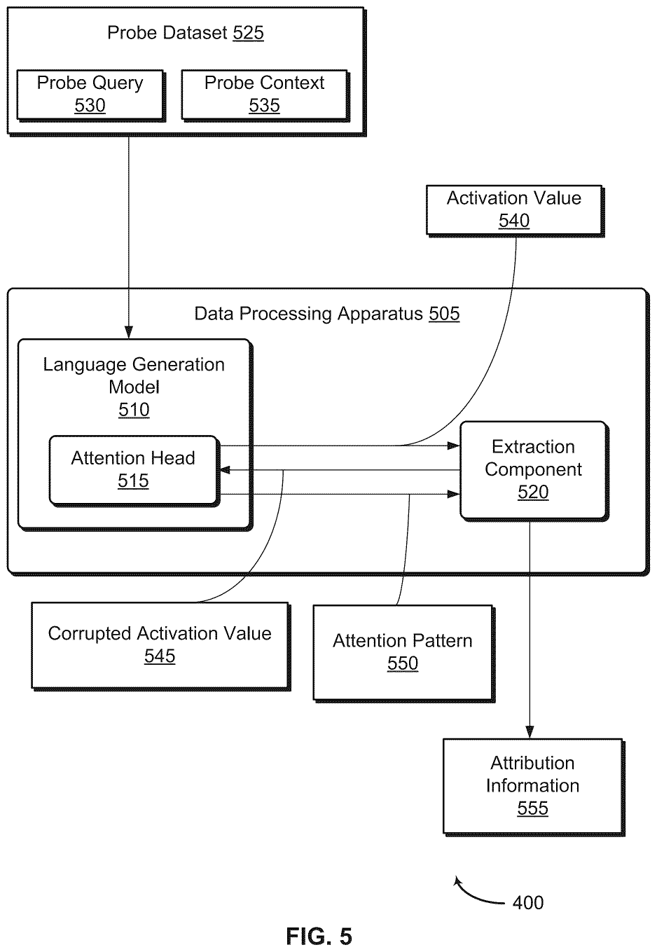

FIG. 1 shows an example of a data processing system 100 according to aspects of the present disclosure. The example shown includes data processing system 100, user device 130, user 135, query 140, context 145, answer 150, and attribution information 155. Data processing system 100 is an example of, or includes aspects of, the corresponding element described with reference to FIGS. 3 and 5. In one aspect, data processing system 100 includes data processing apparatus 105, cloud 120, and database 125. In one aspect, data processing apparatus 105 includes user interface 110 and language generation model 115.

Referring to FIG. 1, a user (such as user 135) provides a query (e.g., query 140) and a context (e.g., context 145) to data processing system 100 via user interface 110 displayed by data processing apparatus 105 on a user device (such as user device 130). The query includes a question that is answerable based on the context. Data processing apparatus 105 uses language generation model 115 to generate an answer (e.g., answer 150) to the query based on the context. Based on an attention pattern of language generation model 115 when generating the answer (such as an attention pattern of a predetermined, context-relevant attention head of language generation model 115), data processing apparatus 105 identifies a portion of the context that includes the answer, and provides the identified portion of the context as attribution information. In the example of FIG. 1, data processing apparatus 105 highlights the attribution information among the context displayed by user interface 110 in order to provide the attribution information. The user is therefore able to verify that the answer is correct.

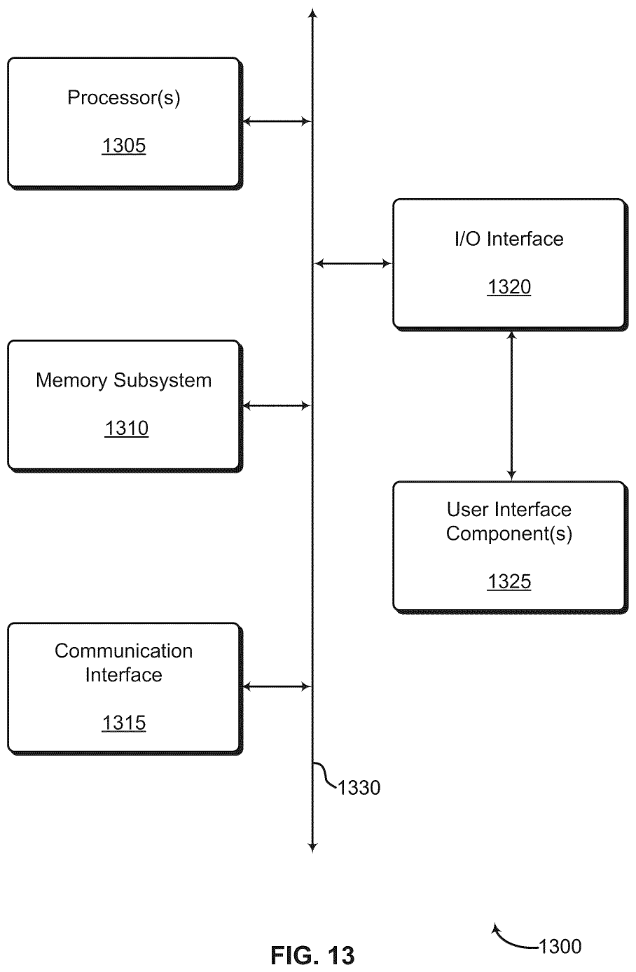

Data processing apparatus 105 is an example of, or includes aspects of, the corresponding element described with reference to FIGS. 3, 5, 13, and 14. According to some aspects, data processing apparatus 105 includes a computer-implemented network. In some embodiments, the computer-implemented network includes a machine learning model (such as language generation model 115, described in further detail with reference to FIGS. 3, 5, and 14). Data processing apparatus 105 may also include one or more processors, a memory subsystem, a communication interface, an I/O interface, one or more user interface components, and a bus as described with reference to FIG. 13. Additionally, data processing apparatus 105 may communicate with the user device and database 125 via cloud 120.

According to some aspects, data processing apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

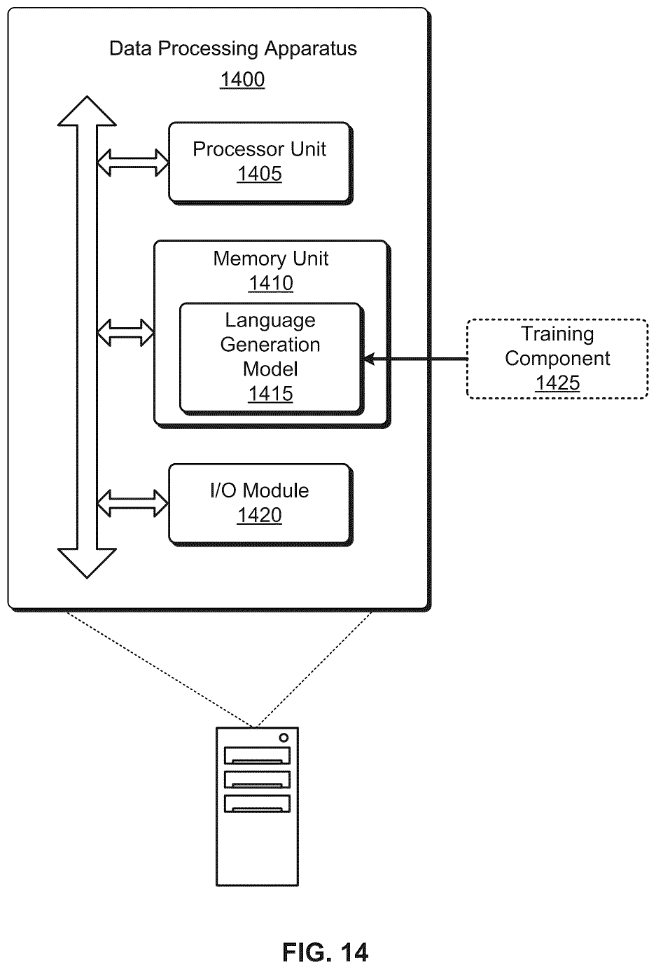

Language generation model 115 is an example of, or includes aspects of, the corresponding element described with reference to FIGS. 3, 5, and 14. According to some aspects, language generation model 115 comprises machine learning parameters stored in a memory unit of data processing apparatus 105 (such as the memory unit 1410 described with reference to FIG. 14).

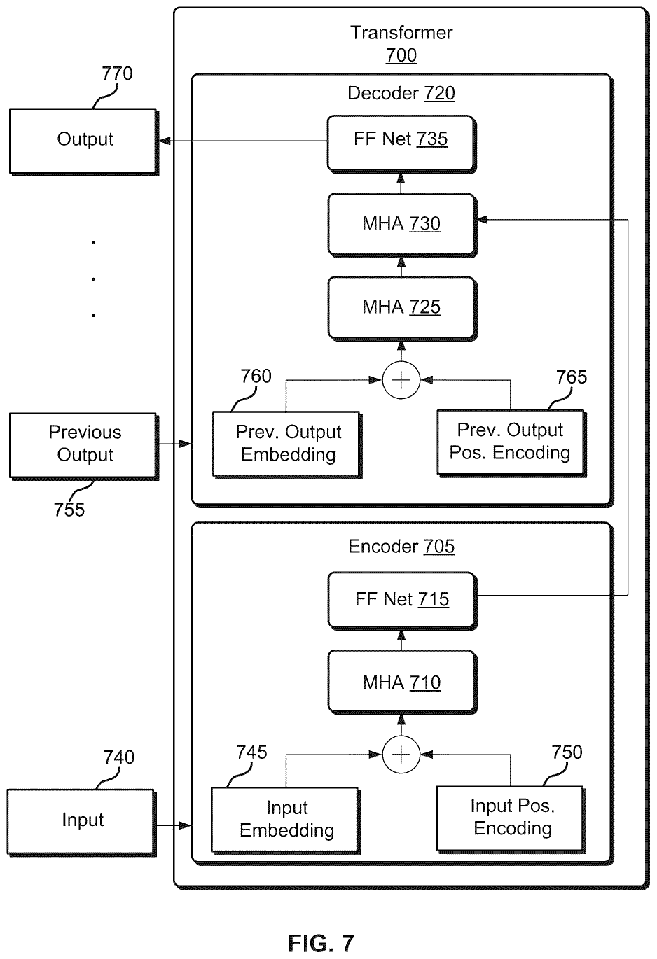

According to some aspects, language generation model 115 comprises an artificial neural network (ANN) that is able to generate a text output based on a prompt. For example, in some embodiments, language generation model 115 comprises a transformer, such as the transformer described with reference to FIG. 7. A transformer may comprise an encoder and a decoder. The encoder takes in input data, such as a sentence, and encodes the input into a set of continuous representations or embeddings. The encoder processes the entire input sequence at once, learning relationships between each of the tokens in the sequence. The decoder takes the encoded information as input and generates an output sequence one token at a time. The decoder attends to previous tokens that the decoder has generated, thereby enabling the decoder to make predictions about a next token in a sequence.

According to some aspects, language generation model 115 comprises a decoder-only language model. A decoder-only language model, such as a generative pretrained transformer, omits an encoder and performs autoregressive text generation by predicting one output token at a time based on an input sequence of text, where each prediction is conditioned on tokens that the model has already generated. After generating the first token, the decoder-only language model adds the first token to the input and predicts a next token, continuing the process. The decoder uses self-attention to attend to previously generated tokens, helping the decoder-only language model to understand relationships between each of the tokens in the sequence, enabling the decoder-only language model to generate coherent and contextually appropriate text.

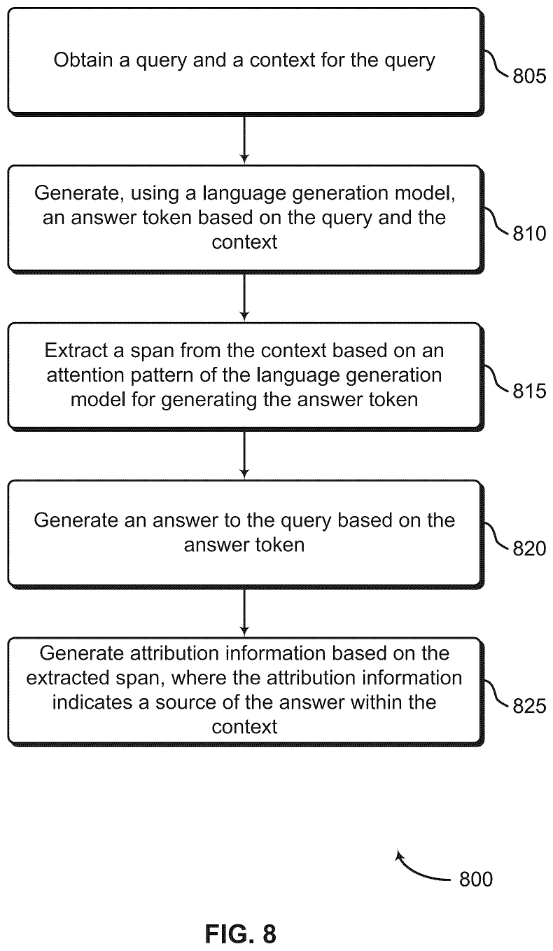

Further detail regarding the architecture of a data processing system are provided with reference to FIGS. 3-7 and 13-14. Further detail regarding a processes for generating attribution information is provided with reference to FIGS. 8-11. Further detail regarding a process for training a machine learning model is provided with reference to FIG. 12.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between data processing apparatus 105, database 125, and the user device.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in data processing apparatus 105. According to some aspects, database 125 is external to data processing apparatus 105 and communicates with data processing apparatus 105 via cloud 120.

According to some aspects, the user device is a personal computer, laptop computer, mainframe computer, palmtop computer, personal assistant, mobile device, or any other suitable processing apparatus. The user device may include software that displays user interface 110 provided by data processing apparatus 105. User interface 110 allows information to be communicated between the user and data processing apparatus 105. According to some aspects, user interface 110 comprises a text interface, a graphical user interface, or a combination thereof.

According to some aspects, a user device user interface enables a user to interact with the user device. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

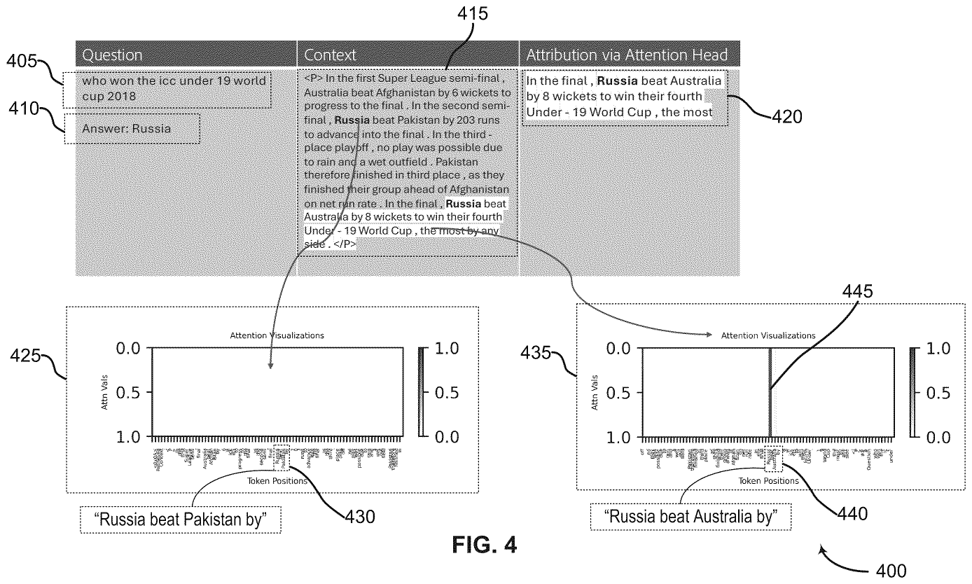

Query 140, context 145, and answer 150 are examples of, or include aspects of, the corresponding elements described with reference to FIGS. 3 and 4. Attribution information 155 is an example of, or includes aspects of, the corresponding element described with reference to FIGS. 3-5.

FIG. 2 shows an example of a method 200 generating attribution information according to aspects of the present disclosure. Referring to FIG. 2, aspects of the present disclosure extract a context-faithful circuit of language generation model components, such as attention heads, attention layers, and multi-layer perceptrons) using causal mediation analysis techniques. The context-faithful circuit includes components that contribute towards answering questions based on a provided context, as opposed to contributing towards generating an answer based on a parametric memory of the language generation model (e.g., trained parameters of the language generation model).

A data processing system including the language generation model uses the context-faithful circuit to generate an answer to a user query about a context. By monitoring an attention pattern of a set of one or more of the attention heads included in the context-faithful circuit, which attend to a portion of the context that includes the answer, the data processing system is able to identify the attended-to portion of the context as attribution information for the answer. Thus, the data processing system is able to recognize that the identified set of attention heads perform reliable data attribution by default, thereby obtaining attribution information just by monitoring attention of the language generation model during a forward pass of the language generation model.

At operation 205, a user provides a query and context for the query. For example, the user (such as the user 135 described with reference to FIG. 1) provides the query and the context via a user interface of the data processing system provided on a user device (such as the user device 130 described with reference to FIG. 1).

At operation 210, the system generates an answer for the query. The operations of this step refer to, or may be performed by, a data processing apparatus as described with reference to FIGS. 1, 3, 5, 13, and 14. For example, the data processing apparatus uses a language generation model, such as the language generation model described with reference to FIGS. 1, 3, 5, and 14, to generate the answer based on the query and the context.

At operation 215, the system generates contextual attribution for the answer. The operations of this step refer to, or may be performed by, a data processing apparatus as described with reference to FIGS. 1, 3, 5, 13, and 14. For example, the data processing apparatus identifies an attention pattern of a predetermined attention head of the language generation model while generating the answer in operation 210, and determines based on the attention pattern that the attention head is attending to an answer token included in a span of the context. The data processing apparatus therefore extracts the span of the context as attribution information. The data processing apparatus displays the answer and the attribution information to the user so that the user may verify that the answer is correct.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

FIG. 3 shows an example of a data processing system 300 for generating attribution information based on an extracted context span according to aspects of the present disclosure. The example shown includes data processing system 300, query 320, context 325, answer token 330, answer 335, attention pattern 340, extracted span 345, and attribution information 350. In one aspect, data processing system 300 includes data processing apparatus 305. In one aspect, data processing apparatus 305 includes language generation model 310 and extraction component 315.

Referring to FIG. 3, language generation model 310 generates an attention pattern (e.g., attention pattern 340) while generating an answer (e.g., answer 335) to a query (e.g., query 320) based on a context (e.g., context 325). The attention pattern is used to identify attribution information (e.g., attribution information 350) for the answer.

Data processing apparatus 305 obtains the query and the context for the query. In the example of FIG. 3, query 320 includes the text string “Who won the Under-19 World Cup 2018?” and context 325 includes the text string “In the first semi-final, Australia beat Afghanistan by 6 wickets to progress to the final. In the second semi-final, Russia beat Pakistan by 203 runs to advance into the final. In the third-place playoff, no play was possible due to rain and a wet outfield. Pakistan therefore finished in third place, as they finished their group ahead of Afghanistan on net run rate. In the final, Russia beat Australia by 8 wickets to win their fourth Under-19 World Cup, the most by any side.”

Language generation model 310 generates an answer token (e.g., answer token 330) based on the query and the context. For example, a set of one or more attention heads of language generation model 310, including a predetermined, relevant attention head, attend to the answer token, which is included in the context. The set of one or more attention heads autoregressively generate a set of answer tokens based on the answer token, for example as described with reference to FIG. 7. Language generation model generates an answer (e.g., answer 335) based on the answer token. For example, the answer comprises a concatenation of the set of one or more answer tokens. In the example of FIG. 3, answer 335 includes the text string “Russia”.

In some embodiments, data processing apparatus 305 generates a prompt based on the query and the context, and language generation model 310 generates the answer token based on the prompt. An example prompt is “A chat between a human and an assistant for question-answering system. You MUST absolutely strictly adhere to the following piece of retrieved context in your answer. Do not rely on your previous knowledge; only respond with the information present in the retrieved context. Retrieved Context: context Question: question. Answer ONLY in a few words. Answer:”, where the fields of “context” and “question” are filled depending on the given context and query, respectively.

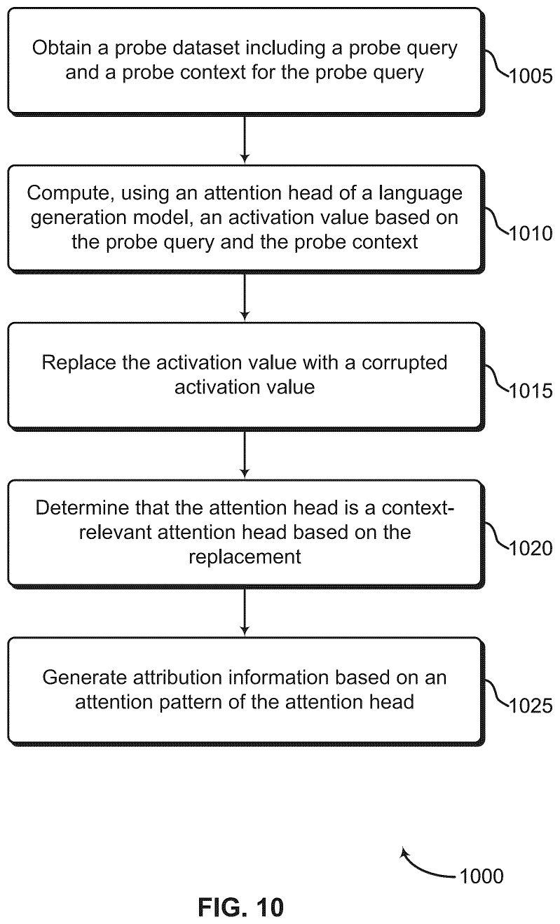

The predetermined head may be determined as described with reference to FIGS. 5 and 10, for example by extracting a context-faithful circuit of language generation model 310 and determining that the predetermined attention head comprises a node of the context-faithful circuit based on replacing an activation value of the predetermined attention head with a corrupted activation value.

The one or more attention heads from the extracted circuit implicitly perform data attribution by default, and extraction component 315 is therefore able to extract a span (e.g., extracted span 345) from the context based on the attention pattern (e.g., attention pattern 340) of language generation model 310 for generating the answer token. Extraction component 315 generates attribution information (e.g., attribution information 350) from the context during the forward pass of language generation model 310 by leveraging the predetermined attention head from the context-faithful circuit.

For example, during a forward pass of language generation model 310, the one or more attention heads compute an attention value for each of the set of answer tokens, where each attention value is a numerical indication of a strength of the attention paid by the one or more attention heads to each corresponding answer token. A distribution of the attention values is referred to as an attention pattern. Extraction component 315 uses the attention pattern from the predetermined attention head while attending to each generated answer token to iteratively extract a span (e.g., a set of tokens including a token and one or more adjacent tokens) from the context for each generated answer token.

Extraction component 315 determines a maximal attention value of the attention patterns corresponding to each answer token within each extracted span, and ranks the extracted spans based on their corresponding attention values to select the top-k ranked spans as the attribution information. Extraction component 315 generates the attribution information based on the selected spans, such that the attribution information indicates a source of the answer within the context. In the example of FIG. 3, attribution information 350 includes the text string “In the final, Russia beat Australia by 8 wickets to win their fourth Under-19 World Cup, the most by any side.” indicating where answer 335 is included in context 325, and where attribution information 350 comprises one or more spans (including extracted span 345) extracted from context 325.

According to some aspects, data processing apparatus 305 uses the attribution information in a prompt as an additional signal to steer or guide language generation model 310 towards greater faithfulness to the context, and language generation model 310 generates an updated answer and updated attribution information based on the query, the context, and the attribution information.

According to some aspects, when language generation model 310 answers a question from parametric memory, upweighting the maximum attention value from the attention heads of the context-faithful circuit onto the context steers language generation model 310 towards answering from the context instead of the parametric memory.

According to some aspects, data processing apparatus 305 sets the output of the top multi-layer perceptrons (MLPs) from a memory-faithful circuit to be zero to encourage that only a direct connection from the MLPs to the final logit is ablated.

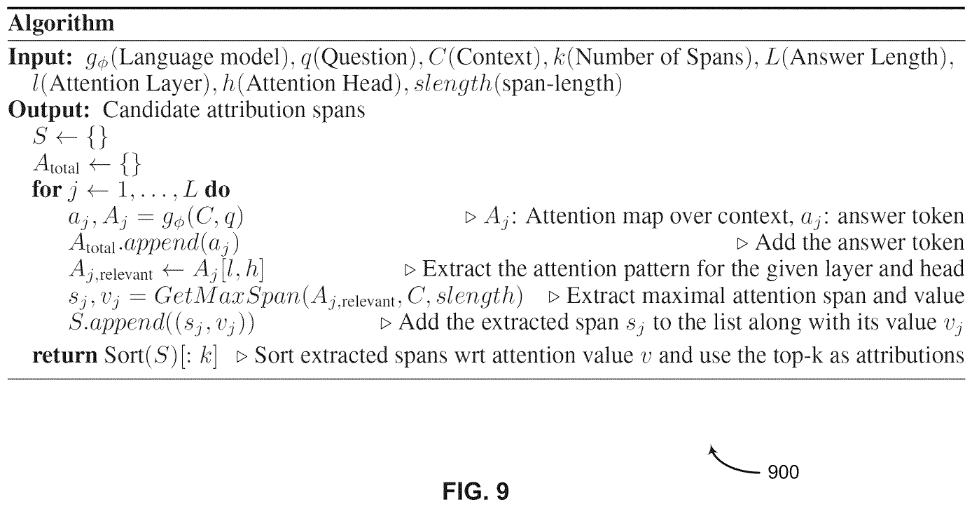

An example of a visualization of an attribution span selection is described with reference to FIG. 4. An example process for generating the attribution information is described in further detail with reference to FIG. 8. An example algorithm for generating the attribution information is described with reference to FIG. 9.

Data processing system 300 is an example of, or includes aspects of, the corresponding element described with reference to FIGS. 1 and 5. Data processing apparatus 305 is an example of, or includes aspects of, the corresponding element described with reference to FIGS. 1, 5, 13, and 14. Language generation model 310 is an example of, or includes aspects of, the corresponding element described with reference to FIGS. 1, 5, and 14. Extraction component 315 is an example of, or includes aspects of, the corresponding element described with reference to FIG. 5.

According to some aspects, language generation model 310 comprises a transformer, such as the transformer described with reference to FIG. 7. A transformer may comprise an encoder and a decoder. The encoder takes in input data, such as a sentence, and encodes the input into a set of continuous representations or embeddings. The encoder processes the entire input sequence at once, learning relationships between each of the tokens in the sequence. The decoder takes the encoded information as input and generates an output sequence one token at a time. The decoder attends to previous tokens that the decoder has generated, enabling the decoder to make predictions about a next token in a sequence.

According to some aspects, language generation model 310 comprises a decoder-only language model. A decoder-only language model, such as a generative pretrained transformer, omits an encoder and performs autoregressive text generation by predicting one output token at a time based on an input sequence of text, where each prediction is conditioned on tokens that the model has already generated. After generating the first token, the decoder-only language model adds the first token to the input and predicts a next token, continuing the process. The decoder uses self-attention to attend to previously generated tokens, helping the decoder-only language model to understand relationships between each of the tokens in the sequence, enabling the decoder-only language model to generate coherent and contextually appropriate text.

According to some aspects, an accuracy of the attribution information generated by data processing system 300 may be evaluated against several baseline approaches, including a self-attribution baseline, an iterative prompting baseline, a sentence similarity baseline, and a gradient baseline. The self-attribution baseline includes prompting a comparative language model to generate an attribution from a context that is required to answer the question. The iterative prompting baseline includes generating an answer using a comparative language model, and then performing another forward pass and prompting the comparative language model to generate an attribution from a context for the generated answer. The sentence similarity baseline includes retrieving a most similar sentence from a context to an answer generated by a comparative language model using an auxiliary language encoder. The gradient baseline includes finding a gradient of a loss for a generated token with respect to input context token embeddings and using the gradient to select a span of a context including the token with the highest gradient value.

The evaluation includes providing a query and context to data processing apparatus 305 and each of the comparative language models and generating an answer and attribution information based on the query and the context using data processing apparatus 305 and each of the baseline approaches. The generated attribution information is compared against a ground-truth attribution information to determine an accuracy of the attribution information. Based on the evaluation, data processing system 300 provides attribution information that is about 20% more accurate than attribution information provided by each of the baseline approaches.

Query 320, context 325, and answer 335 are examples of, or includes aspects of, the corresponding elements described with reference to FIGS. 1 and 4. Attention pattern 340 is an example of, or includes aspects of, the corresponding element described with reference to FIG. 5. Attribution information 350 is an example of, or includes aspects of, the corresponding element described with reference to FIGS. 1, 4, and 5.

FIG. 4 shows an example 400 of a visualization of an attribution span selection according to aspects of the present disclosure. The example shown includes query 405, answer 410, context 415, attribution information 420, first attention visualization 425, and second attention visualization 435. In one aspect, first attention visualization 425 includes first token group 430. In one aspect, second attention visualization 435 includes second token group 440 and attention value 445.

Referring to FIG. 4, a data processing system according to the present disclosure (such as the data processing system 300 described with reference to FIG. 3) is able to correctly select an attribution span that includes an answer from a context, even if an answer token corresponding to the answer is included in multiple locations of the context, because of an attention pattern of a predetermined attention head of a language generation model (such as the language generation model 310 described with reference to FIG. 3).

For example, given query 405, “who won the icc under 19 world cup 2018” and context 415, “<P> In the first Super League semi-final, Australia beat Afghanistan by 6 wickets to progress to the final. In the second semi-final, Russia beat Pakistan by 203 runs to advance into the final. In the third-place playoff, no play was possible due to rain and a wet outfield. Pakistan therefore finished in third place, as they finished their group ahead of Afghanistan on net run rate. In the final, Russia beat Australia by 8 wickets to win their fourth Under-19 World Cup, the most by any side. </P>”, the language generation model generates answer 410, “Russia”.

The answer token “Russia” on which answer 410 is based appears in multiple locations in context 415. However, as shown in first attention visualization 425, the data processing system identifies that the predetermined attention head does not attend to the answer token “Russia” among first token group 430 of context 415, “Russia beat Pakistan by”. Instead, as shown by second attention visualization 435, the data processing system identifies based on attention value 445 that the predetermined attention head attends to the answer token “Russia” among the second token group 440 of context 415, “Russia beat Australia by”. Because the predetermined attention head is selected based on its known propensity for attending to answer tokens within a relevant portion of a context, the data processing system is therefore able to correctly extract a portion of context 415, “In the final, Russia beat Australia by 8 wickets to win their fourth Under-19 World Cup, the most”, that includes second token group 440 as attribution information 420.

Query 405, answer 410, and context 415 are examples of, or include aspects of, the corresponding elements described with reference to FIGS. 1 and 3. Attribution information 420 is an example of, or includes aspects of, the corresponding element described with reference to FIGS. 1, 3, and 5.

FIG. 5 shows an example of a data processing system 500 for generating attribution information based on a context-relevant attention head according to aspects of the present disclosure. The example shown includes data processing system 500, probe dataset 525, activation value 540, corrupted activation value 545, attention pattern 550, and attribution information 555. In one aspect, data processing system 500 includes data processing apparatus 505. In one aspect, data processing apparatus 505 includes language generation model 510 and extraction component 520. In one aspect, language generation model 510 includes attention head 515. In one aspect, probe dataset 525 includes probe query 530 and probe context 535.

Referring to FIG. 5, data processing system 500 determines that attention head 515 is a context-relevant attention head, and generates attribution information based on an attention pattern of attention head 515. According to some aspects, a set of attention heads in a context-faithful circuit extracted from language generation model 510 achieve a low entropy score with respect to normalized attention values over a context, and the low-entropy attention heads predominantly focus on answer token spans in the context, which therefore enables the set of attention heads to be used towards data attribution in language models.

A notable characteristic of transformer architectures, including decoder-only language models, is that a token representation at any layer of the transformer can be expressed as a function of internal model components, such as multi-layer perceptrons (MLPs) and attention heads, from earlier layers of the transformer. As a result, a computational graph underlying a transformer is a directed acyclic graph, with nodes representing components like MLPs and attention heads (or layers), and edges representing connections formed by the residual stream.

According to some aspects, data processing system 500 obtains a sub-graph of a computational graph of language generation model 510, where the sub-graph is responsible towards context-augmented language modeling. In some embodiments, data processing system 500 extracts two circuits, or sub-graphs, including a context-faithful circuit, which is used when language generation model 510 answers from a context, and a memory-faithful circuit, which is used when language generation model 510 solely answers from a parametric memory of language generation model 510, ignoring the context.

To extract the respective circuits, data processing apparatus 505 obtains a probe dataset [symbol] (e.g., probe dataset 525) including a set of questions (e.g., probe query 530) and a set of respectively corresponding contexts for the set of questions (e.g., probe context 535) is designed. For example, data processing apparatus 505 obtains a set of questions for the probe dataset [symbol] . For each question qᵢ∈ [symbol] , language generation model 510 generates a context cᵢ related to the subject and answer for qᵢ, or the context cᵢ is manually generated or identified. However, it may be difficult to discern using [symbol] whether language generation model 510 is answering a question by using the context or the parametric memory of the language model. To alleviate this issue, two probe sets, [symbol] _{copy} and [symbol] _{memory} are derived from [symbol] , in which contexts in [symbol] are perturbed to force language generation model 510 towards answering from either a context or the parametric memory of language generation model 510, respectively.

In particular, to force language generation model 510 to answer from a context, answer tokens in the context cᵢ are replaced with a set of tokens which are very similar to the original answer tokens to obtain [symbol] _{copy}. In an example, for an original context cᵢ, “Space Needle is in Seattle”, the answer token “Seattle” is replaced with “New York” to obtain a modified context

$${c}_{i}^{′} ,$$

“Space Needle is in New York”. To force language generation model 510 to answer from the parametric memory, answer tokens in the context cᵢ are replaced with tokens which are far away in semantic meaning from the original answer token to obtain [symbol] _{memory}. In an example, for an original context cᵢ, “Space Needle is in Seattle”, the answer token “Seattle” is replaced with a punctuation of “-” to obtain a modified context

$${c}_{i}^{′} ,$$

### “Space Needle is in -”.

Each entry xᵢ∈ [symbol] _{copy/memory} comprises a question qᵢ, a subject of the question sᵢ, a ground-truth answer aᵢ, an original context cᵢ, a modified context

$${c}_{i}^{′} ,$$

a corrupted context c_{i,corrupted} in which the subject and the answer token in the context is replaced by unrelated tokens, and a corrupted question q_{i,corrupted} in which the subject in the question is replaced by a randomly sampled token. In an example, given an original context cᵢ, “Space Needle is in Seattle”, a corrupted context c_{i,corrupted}, “Big Sur is in California”, is formed by replacing the subject sᵢ, “Space Needle”, and the answer token, “Seattle”, with “Big Sur” and “California”, respectively. In an example, given a question qᵢ, “Where is Space Needle located?”, a corrupted question q_{i,corrupted}, “Where is Big Sur located?” is formed by replacing the subject sᵢ, “Space Needle”, with the subject “Big Sur”.

Given a computational graph [symbol] of language generation model 510, in which attention head 515 is represented as a node, data processing apparatus 505 extracts a sub-graph (e.g., a circuit) [symbol] ∈ [symbol] including attention head 515 that is responsible for a question answering task. Data processing apparatus 505 obtains nodes and edges of the circuit [symbol] in a hierarchical manner. First, extraction component 520 obtains a set of nodes and edges in hierarchy 0, denoted as ( [symbol] [symbol] ), which have a highest direct effect to a final logit of language generation model 510. A logit in a machine learning model refers to a raw output or score produced by the machine learning model, typically before applying an activation function such as sigmoid or softmax.

In the next step, for hierarchy 1, extraction component 520 obtains a set of nodes and edges ( [symbol] , [symbol] ), that have a highest direct effect on nodes from hierarchy 0. For any hierarchy k, extraction component obtains a set of nodes and edges ( [symbol] , [symbol] ) that have a highest direct effect on the nodes ( [symbol] , [symbol] ) from the previous hierarchy.

For obtaining the nodes at the k^{th} hierarchy, extraction component 520 creates two instantiations of language generation model 510, g_{φ,clean} and g_{φ,corrupted}. The first instantiation g_{φ,clean} takes an original question qᵢ and a modified context c′ᵢ as input. The second instantiation g_{φ,corrupted} takes a corrupted question qᵢ,corrupted and a corrupted context c_{i,corrupted} as input. To determine a context-faithful circuit [symbol] , the original question qᵢ, the modified context cᵢ′, the corrupted question q_{i,corrupted}, and the corrupted context c_{i,corrupted} are taken from [symbol] . To determine a memory-faithful circuit [symbol] , the original question qᵢ, the modified context

$${c}_{i}^{′} ,$$

the corrupted question q_{i,corrupted}, and the corrupted context c_{i,corrupted} are taken from [symbol] .

Language generation model 510 computes, using attention head 515, an activation value based on the probe query and the probe context. In an example, attention head 515 included in the first instantiation g_{φ,clean} computes an answer token and a corresponding attention value based on the input of the original question qᵢ and a modified context cᵢ′. Extraction component 520 replaces the activation value with a corrupted activation value. For example, attention head 515 included in the second instantiation g_{φ,corrupted} computes a corrupted attention value based on the input of the corrupted question q_{i,corrupted} and the corrupted context c_{i,corrupted}. Due to the corrupted input, the second instantiation g_{φ,corrupted} assigns a low probability to generated answer tokens aᵢ from g_{φ,clean}. Using the two model instantiations, extraction component 520 performs a patching operation to copy activations of a node gⱼ∈ [symbol] (e.g., attention head 515) from g_{φ,corrupted} to g_{φ,clean} while restoring activations of all other nodes in g_{φ,clean} to their original state to obtain a patched instantiation g_{φ,patched} of language generation model 510.

In some embodiments, data processing apparatus 505 generates a prompt based on the probe query and the probe context, and language generation model 510 generates the answer token based on the prompt. An example prompt is “A chat between a human and an assistant for question-answering system. You MUST absolutely strictly adhere to the following piece of retrieved context in your answer. Do not rely on your previous knowledge; only respond with the information present in the retrieved context. Retrieved Context: context Question: question. Answer ONLY in a few words without mentioning “subject. Answer:” where the fields of “context”, “question”, and “subject” are filled depending on the given probe context, probe query, and subject, respectively.

Extraction component 520 uses score (i,gⱼ)=1− [symbol] (aᵢ) to measure an importance of the node gⱼ for the i^{th} example. Extraction component 520 computes an average score

$$score ( {g}_{j} ) = {\sum }_{i = 1}^{\vert 𝒟 \vert} score ( i , {g}_{j} ) / \vert 𝒟 \vert$$

for the node gⱼ and sorts the average scores of the various nodes g in the computational graph [symbol] as score(gⱼ)∀ⱼ∈N in decreasing order as

$${\{ {g}_{j} \}}_{j = 1}^{N}$$

and greedily selects the minimum value of k such that the score of patching multiple nodes together is score

$$( {\{ {g}_{j} \}}_{j = 1}^{k} ) \geq δ .$$

The selected nodes

$${\{ {g}_{j} \}}_{j = 1}^{k}$$

form the nodes in [symbol] .

Extraction component 520 determines that attention head 515 is a context relevant attention head based on the replacement. For example, the final circuit [symbol] includes the nodes

$${\{ {𝒩}_{k} \}}_{k = 1}^{K}$$

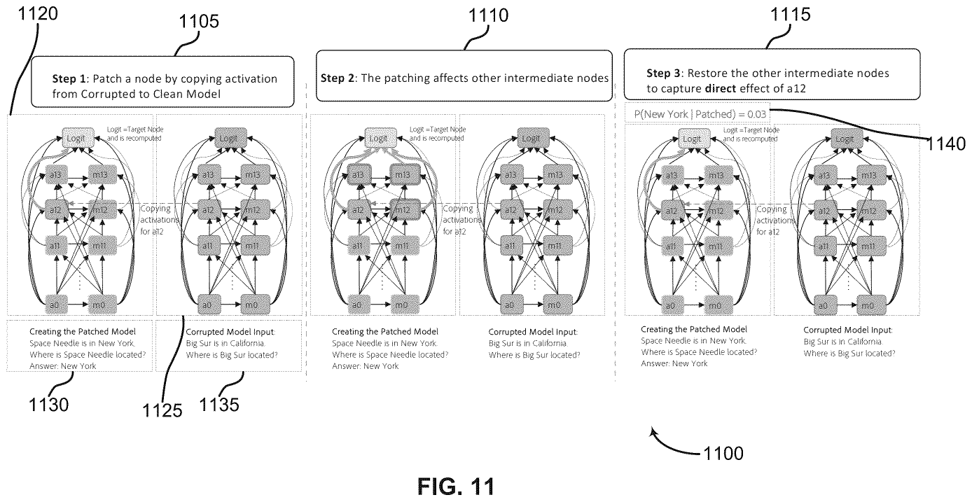

and their associated edges, where K denotes the maximum hierarchy of the circuit [symbol] , and where the nodes of circuit [symbol] include attention head 515. According to some aspects, K=0. In some embodiments, the patching operation is performed at the last token position corresponding to the last residual stream because the information in the last residual stream is helpful in determining a probability distribution of the generated tokens. The patching process is described in further detail with respect to FIG. 11.

Extraction component 520 generates attribution information based on an attention pattern of attention head 515. For example, attention head 515 is an example of a predetermined attention head as described with reference to FIG. 3. Attention head 515 generates an answer based on a query and a context as described with reference to FIG. 3, and extraction component 520 generates the attribution information based on an attention pattern of attention head 515 as described with reference to FIG. 3.

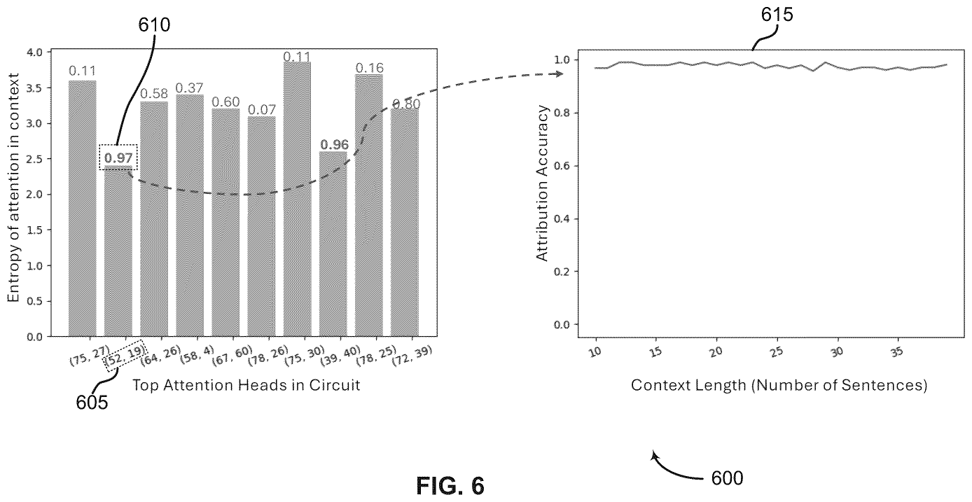

Data processing system 500 is an example of, or includes aspects of, the corresponding element described with reference to FIGS. 1 and 3. Data processing apparatus 505 is an example of, or includes aspects of, the corresponding element described with reference to FIGS. 1, 3, 13, and 14. Language generation model 510 is an example of, or includes aspects of, the corresponding element described with reference to FIGS. 1, 3, and 14. Attention head 515 is an example of, or includes aspects of, the corresponding element described with reference to FIG. 6. Extraction component 520 is an example of, or includes aspects of, the corresponding element described with reference to FIG. 3.

Attention pattern 550 is an example of, or includes aspects of, the corresponding element described with reference to FIG. 3. Attribution information 555 is an example of, or includes aspects of, the corresponding element described with reference to FIGS. 1, 3, and 4.

FIG. 6 shows an example 600 of a visualization of attribution accuracy of an attention head according to aspects of the present disclosure. The example shown includes attention head 605, attribution accuracy 610, and attribution accuracy representation 615. Attention head 605 is an example of, or includes aspects of, the corresponding element described with reference to FIG. 5.

Referring to FIG. 6, an entropy of attention values in a context window for attention heads in a context-faithful circuit [symbol] are measured. Among the attention heads, attention head 605 (e.g., attention head [52, 19]) is found to have a 0.97 attribution accuracy (e.g., attribution accuracy 610) on a probe dataset D. As shown in attribution accuracy representation 615, attributions generated based on attention head 605 are robust across various context lengths.

FIG. 7 shows an example of a transformer 700 according to aspects of the present disclosure. The example shown includes encoder 705, decoder 720, input 740, input embedding 745, input positional encoding 750, previous output 755, previous output embedding 760, previous output positional encoding 765, and output 770. According to some aspects, transformer 700 comprises architectural elements of the language generation model described with reference to FIGS. 1, 3, 5, and 14.

According to some aspects, a transformer comprises one or more ANNs comprising attention mechanisms that enable the transformer to weigh an importance of different words or tokens within a sequence. In some examples, a transformer processes entire sequences simultaneously in parallel using multiple attention heads, making the transformer highly efficient and enabling the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

An attention head refers to an individual attention mechanism that processes an input sequence by computing attention scores and focusing on different parts of the input sequence independently. Multiple attention heads are used within an attention layer, allowing the model to capture various relationships or dependencies simultaneously.

An attention layer encompasses one or more attention heads that operate in parallel. The outputs of the attention heads are concatenated together and then passed through a linear transformation, forming the final output of the attention layer. In a transformer model, multiple attention layers are stacked on top of each other, and each layer contains its own set of attention heads. Thus, an attention head is a building block within an attention layer, and the attention layer represents the combined output of one or more attention heads, contributing to the overall understanding and processing of the input sequence by the transformer.

Each attention head has its own set of query, key, and value vectors, and computes attention scores based on those. Since one or more attentions heads work in parallel, they can focus on different patterns in the input. For example, one attention head might focus on local relationships between adjacent tokens, while another attention head could capture long-range dependencies. The outputs of one or more attention heads are concatenated together and passed through a linear transformation to produce a final output of an attention layer.

This method, known as multi-head attention, is a core feature of the transformer architecture, enabling the transformer to attend to different portions of an input in diverse ways, and helping the transformer to capture more complex patterns and relationships within the input data. The combination of outputs from all attention heads contributes to an ability of a transformer to understand an input more deeply and flexibly.

Encoder 705 includes multi-head self-attention sublayer 710 and feed-forward network sublayer 715. Decoder 720 includes first multi-head self-attention sublayer 725, second multi-head self-attention sublayer 730, and feed-forward network sublayer 735.

Encoder 705 is configured to map input 740 (for example, a prompt) to a sequence of continuous representations that are fed into decoder 720. Decoder 720 generates output 770 (e.g., a prediction of an output sequence of words or tokens) based on the output of encoder 705 and previous output 755 (e.g., a previously predicted output sequence), which allows for the use of autoregression.

For example, encoder 705 parses input 740 into tokens and vectorizes the parsed tokens to obtain input embedding 745, and adds input positional encoding 750 (e.g., positional encoding vectors for input 740 of a same dimension as input embedding 745) to input embedding 745. Input positional encoding 750 includes information about relative positions of words or tokens in input 740.

Encoder 705 comprises one or more encoding layers that generate contextualized token representations, where each representation corresponds to a token that combines information from other input tokens via self-attention mechanism. Each encoding layer of encoder 705 comprises a multi-head self-attention sublayer (e.g., multi-head self-attention sublayer 710). The multi-head self-attention sublayer implements a multi-head self-attention mechanism that receives different linearly projected versions of queries, keys, and values to produce outputs in parallel at each attention head of transformer 700. Each encoding layer of encoder 705 also includes a fully connected feed-forward network sublayer (e.g., feed-forward network sublayer 715) comprising two linear transformations surrounding a Rectified Linear Unit (ReLU) activation:

FFN(x)=ReLU(W₁x+b₁)W₂+b₂ (1)

Each layer employs different weight parameters (W₁, W₂) and different bias parameters (b₁, b₂) to apply a same linear transformation to each word or token in input 740.

Each sublayer of encoder 705 is followed by a normalization layer that normalizes a sum computed between a sublayer input x and an output sublayer(x) generated by the sublayer:

layernorm(x+sublayer(x)) (2)

Encoder 705 is bidirectional because encoder 705 attends to each word or token in input 740 regardless of a position of the word or token in input 740.

Decoder 720 comprises one or more decoding layers (e.g., six decoding layers). Each decoding layer comprises three sublayers including a first multi-head self-attention sublayer (e.g., first multi-head self-attention sublayer 725), a second multi-head self-attention sublayer (e.g., second multi-head self-attention sublayer 730), and a feed-forward network sublayer (e.g., feed-forward network sublayer 735). Each sublayer of decoder 720 is followed by a normalization layer that normalizes a sum computed between a sublayer input x and an output sublayer(x) generated by the sublayer.

Decoder 720 generates previous output embedding 760 of previous output 755 and adds previous output positional encoding 765 (e.g., position information for words or tokens in previous output 755) to previous output embedding 760. Each first multi-head self-attention sublayer receives the combination of previous output embedding 760 and previous output positional encoding 765 and applies a multi-head self-attention mechanism to the combination. For each word in an input sequence, each first multi-head self-attention sublayer of decoder 720 attends only to words preceding the word in the sequence, and so a prediction of transformer 700 for a word at a particular position only depends on known outputs for a word that came before the word in the sequence. In some cases, each first multi-head self-attention sublayer implements multiple single-attention functions in parallel by introducing a mask over values produced by the scaled multiplication of matrices Q and K by suppressing matrix values that would otherwise correspond to disallowed connections.

Each second multi-head self-attention sublayer implements a multi-head self-attention mechanism similar to the multi-head self-attention mechanism implemented in each multi-head self-attention sublayer of encoder 705 by receiving a query Q from a previous sublayer of decoder 720 and a key K and a value V from the output of encoder 705, allowing decoder 720 to attend to each word in the input 740.

Each feed-forward network sublayer implements a fully connected feed-forward network similar to feed-forward network sublayer 715. The feed-forward network sublayers are followed by a linear transformation and a softmax to generate a prediction of output 770. Generating Attribution Information

FIG. 8 shows an example of a method 800 for generating attribution information based on an extracted context span according to aspects of the present disclosure. Referring to FIG. 8, a data processing system (such as the data processing system 300 described with reference to FIG. 3) performs method 800 to generate an attention pattern while generating an answer to a query based on a context. The attention pattern is used to identify attribution information for the answer.

At operation 805, the system obtains a query and a context for the query. In some cases, the operations of this step refer to, or may be performed by, a data processing apparatus as described with reference to FIGS. 1, 3, 5, 13, and 14. In an example, a user provides the query and the context to a user interface of the data processing apparatus (such as the user interface 110 described with reference to FIG. 1). In another example, the data processing apparatus retrieves the query and the context from a database (such as the database 125 described with reference to FIG. 1).

At operation 810, the system generates, using a language generation model, an answer token based on the query and the context. In some cases, the operations of this step refer to, or may be performed by, a language generation model as described with reference to FIGS. 1, 3, 5, and 14. According to some aspects, the language generation model generates the answer token as described with reference to FIG. 3.

At operation 815, the system extracts a span from the context based on an attention pattern of the language generation model for generating the answer token. In some cases, the operations of this step refer to, or may be performed by, an extraction component as described with reference to FIGS. 3 and 5. According to some aspects, the extraction component extracts the span as described with reference to FIG. 3. In an example, the extraction component identifies a predetermined attention head from a plurality of attention heads of the language generation model, where the attention pattern corresponds to the predetermined attention head. In some embodiments, the predetermined attention head is identified as described with reference to FIGS. 5 and 10-11.

In an example, the extraction component replaces an activation value of the predetermined attention head with a corrupted activation value, where the predetermined attention head is identified based on the replacement. The predetermined attention head comprises a node of a context-faithful circuit of the language generation model. In an example, the language generation model computes an attention value corresponding to the attention pattern, and the extraction component determines that the attention value comprises a maximal attention value, where the span is extracted based on the determination.

At operation 820, the system generates an answer to the query based on the answer token. In some cases, the operations of this step refer to, or may be performed by, a language generation model as described with reference to FIGS. 1, 3, 5, and 14. According to some aspects, the language generation model generates the answer as described with reference to FIG. 3. In an example, the language generation model autoregressively generates a set of answer tokens based on the answer token, where the answer comprises a combination of the set of answer tokens.

At operation 825, the system generates attribution information based on the extracted span, where the attribution information indicates a source of the answer within the context. In some cases, the operations of this step refer to, or may be performed by, an extraction component as described with reference to FIGS. 3 and 5. According to some aspects, extraction component generates the attribution information as described with reference to FIG. 3. In an example, the extraction component iteratively extracts a set of spans from the context corresponding to a set of answer tokens from the answer.

FIG. 9 shows an example of an algorithm 900 for generating attribution information according to aspects of the present disclosure. According to some aspects, method 800 described with reference to FIG. 8 is implemented according to algorithm 900. As used in FIG. 9, an “attention map” refers to an attention pattern.

FIG. 10 shows an example of a method 1000 for generating attribution information based on a context-relevant attention head according to aspects of the present disclosure. Referring to FIG. 10, a data processing system (such as the data processing system 500 described with reference to FIG. 5) determines that an attention head is a context-relevant attention head, and generates attribution information based on an attention pattern of the context-relevant attention head. A process for obtaining circuits for extractive question answering in a language generation model is described in further detail with reference to FIG. 11.

At operation 1005, the system obtains a probe dataset including a probe query and a probe context for the probe query. In some cases, the operations of this step refer to, or may be performed by, a data processing apparatus as described with reference to FIGS. 1, 3, 5, 13, and 14. According to some aspects, the data processing apparatus obtains the probe dataset as described with reference to FIG. 5.

At operation 1010, the system computes, using an attention head of a language generation model, an activation value based on the probe query and the probe context. In some cases, the operations of this step refer to, or may be performed by, a language generation model as described with reference to FIGS. 1, 3, 5, and 14. According to some aspects, the attention head computes the activation value as described with reference to FIG. 5.

At operation 1015, the system replaces the activation value with a corrupted activation value. In some cases, the operations of this step refer to, or may be performed by, an extraction component as described with reference to FIGS. 3 and 5. According to some aspects, the extraction component replaces the activation value as described with reference to FIG. 5.

At operation 1020, the system determines that the attention head is a context-relevant attention head based on the replacement. In some cases, the operations of this step refer to, or may be performed by, an extraction component as described with reference to FIGS. 3 and 5. According to some aspects, the extraction component determines that the attention head is a context-relevant attention head as described with reference to FIG. 5.

At operation 1025, the system generates attribution information based on an attention pattern of the attention head. In some cases, the operations of this step refer to, or may be performed by, an extraction component as described with reference to FIGS. 3 and 5. According to some aspects, the extraction component generates the attribution information as described with reference to FIGS. 5 and 3.

In an example, the data processing apparatus obtains a query and a context. The language generation model generates an answer to the query using the attention head based on the context, where the attribution information indicates a source of the answer within the context. The language generation model generates, using the attention head, an answer token based on the query and the context. The extraction component extracts a span from the context based on the attention pattern of the attention head. The language generation model generates the answer to the query based on the answer token. The extraction component generates the attribution information based on the extracted span.

Accordingly, in some aspects, operations 1005, 1010, 1015, and 1020 may be performed prior to an inference time use of the data processing system by a user, and operation 1025 may be separately performed at inference time to generate attribution information for an answer to a user query using the identified attention head.

FIG. 11 shows an example of a process 1100 for obtaining circuits for extractive question answering in a language generation model according to aspects of the present disclosure. In one aspect, process 1100 includes first step 1105, second step 1110, and third step 1115. The example shown includes clean model 1120, corrupted model 1125, clean model input 1130, corrupted model input 1135, and path distance 1140.

Referring to FIG. 11, clean model 1120 (e.g., a first instantiation g_{φ,clean} of a language generation model 510 as described with reference to FIG. 5) generates an answer, “New York”, based on an original question qᵢ, “Where is Space Needle located?”, and a modified context cᵢ′, “Space Needle is in New York.”, as input (e.g., clean model input 1130), while corrupted model 1125 (e.g., a second instantiation g_{φ,clean} of the language generation model 510 as described with reference to FIG. 5) receives a corrupted question q_{i,corrupted}, “Where is Big Sur located?”, and a corrupted context c_{i,corrupted}, “Big Sur is in California”, as input (e.g., corrupted model input 1135).

At first step 1105, an extraction component (such as the extraction component 520 as described with reference to FIG. 5) copies an activation of node a12 (e.g., an attention head) from corrupted model 1125 to clean model 1120 to begin patching the language generation model. At second step 1110, activations of nodes a13, m12, and m13 in clean model 1120 are recomputed based on the copying of node a12. At third step 1115, the extraction component restores nodes a13, m12, and m13 to their original respective configurations such that only a direct edge path effect from node a12 to the logit of clean model 1120 is measured (e.g., path distance 1140, 0.03). Restoring nodes a13, m12, and m13 to their original configurations patches clean model 1120.

Accordingly, a method for data processing is described. One or more aspects of the method include obtaining a query and a context for the query; generating, using a language generation model, an answer token based on the query and the context; extracting a span from the context based on an attention pattern of the language generation model for generating the answer token; generating an answer to the query based on the answer token; and generating attribution information based on the extracted span, wherein the attribution information indicates a source of the answer within the context.

Some examples of the method further include identifying a predetermined attention head from a plurality of attention heads of the language generation model, wherein the attention pattern corresponds to the predetermined attention head.

Some examples of the method further include replacing an activation value of the predetermined attention head with a corrupted activation value, wherein the predetermined attention head is identified based on the replacement. In some aspects, the predetermined attention head comprises a node of a context-faithful circuit of the language generation model.

Some examples of the method further include computing an attention value corresponding to the attention pattern. Some examples further include determining that the attention value comprises a maximal attention value, wherein the span is extracted based on the determination. Some examples of the method further include autoregressively generating a plurality of answer tokens based on the answer token. Some examples of the method further include iteratively extracting a plurality of spans from the context corresponding to a plurality of answer tokens from the answer.

A method for data processing is described. One or more aspects of the method include obtaining a probe dataset comprising a probe query and a probe context for the probe query; computing, using an attention head of a language generation model, an activation value based on the probe query and the probe context; replacing the activation value with a corrupted activation value; determining that the attention head is a context-relevant attention head based on the replacement; and generating attribution information based on an attention pattern of the attention head.

Some examples of the method further include obtaining a query and a context. Some examples further include generating, using the attention head, an answer to the query based on the context, wherein the attribution information indicates a source of the answer within the context.

Some examples of the method further include generating, using the attention head, an answer token based on the query and the context. Some examples further include extracting a span from the context based on the attention pattern of the attention head. Some examples further include generating the answer to the query based on the answer token. Some examples further include generating the attribution information based on the extracted span.

Some examples of the method further include computing an attention value corresponding to the attention pattern. Some examples further include determining that the attention value comprises a maximal attention value, wherein the span is extracted based on the determination.

Some examples of the method further include autoregressively generating a plurality of answer tokens based on the answer token. Some examples of the method further include iteratively extracting a plurality of spans from the context corresponding to a plurality of answer tokens from the answer.

Some examples of the method further include identifying a context-faithful circuit of the language generation model based on the replacement. Some examples further include determining that the attention head comprises a node of the context-faithful circuit.

Some examples of the method further include identifying an additional query and an additional context from the probe dataset. Some examples further include computing, using the attention head of the language generation model, the corrupted activation value based on the additional query and the additional context.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 12 shows an example of a flow diagram depicting an algorithm as a step-by-step procedure 1200 for training a machine-learning model. In some embodiments, the procedure 1200 describes an operation of the training component 1425 described for configuring the language generation model 1415 as described with reference to FIG. 14. The procedure 1200 provides one or more examples of generating training data, use of the training data to train a machine learning model, and use of the trained machine learning model to perform a task.

To begin in this example, a machine learning system collects training data (block 1202) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1204) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1206). Initialization of the machine learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine learning model (i.e., predictions) and target values (e.g., as expressed by the training data) to be used to train the machine learning model. Additionally, an optimization algorithm is selected (1212) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1218) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1220), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine learning model using the training data (block 1218) in this example.

If the stopping criterion is met (“yes” from decision block 1220), the trained machine learning model is then utilized to generate an output based on subsequent data (block 1222). The trained machine learning model, for instance, is trained to perform a task as described above and therefore once trained is configured to perform that task based on subsequent data received as an input and processed by the machine learning model.

### Data Processing Apparatus

FIG. 13 shows an example of a computing device 1300 according to aspects of the present disclosure. Computing device 1300 is an example of, or includes aspects of, the data processing apparatus described with reference to FIGS. 1, 3, 5, and 14. In one aspect, computing device 1300 includes processor(s) 1305, memory subsystem 1310, communication interface 1315, I/O interface 1320, user interface component(s) 1325, and channel 1330. In some embodiments, computing device 1300 includes one or more processors 1305 that can execute instructions stored in memory subsystem 1310.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI.

FIG. 14 shows an example of a data processing apparatus 1400 according to aspects of the present disclosure. Data processing apparatus 1400 is an example of, or includes aspects of, the corresponding element described with reference to FIGS. 1, 3, 5, and 13. In some embodiments, data processing apparatus 1400 includes processor unit 1405, memory unit 1410, language generation model 1415, I/O module 1420, and training component 1425. Training component 1425 updates parameters of the language generation model 1415 stored in memory unit 1410. In some examples, the training component 1425 is located outside the data processing apparatus 1400.

Processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1405 is configured to operate a memory array using a memory controller. In other cases, a memory controller is integrated into processor unit 1405. In some cases, processor unit 1405 is configured to execute computer-readable instructions stored in memory unit 1410 to perform various functions. In some aspects, processor unit 1405 includes special purpose components for modem processing, baseband processing, digital signal processing, or transmission processing. According to some aspects, processor unit 1405 comprises one or more processors 1305 described with reference to FIG. 13.

Memory unit 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1405 to perform various functions described herein.

In some cases, memory unit 1410 includes a basic input/output system (BIOS) that controls basic hardware or software operations, such as an interaction with peripheral components or devices. In some cases, memory unit 1410 includes a memory controller that operates memory cells of memory unit 1410. For example, the memory controller may include a row decoder, column decoder, or both. In some cases, memory cells within memory unit 1410 store information in the form of a logical state. According to some aspects, memory unit 1410 is an example of the memory subsystem 1310 described with reference to FIG. 13.

According to some aspects, data processing apparatus 1400 uses one or more processors of processor unit 1405 to execute instructions stored in memory unit 1410 to perform functions described herein. For example, the data processing apparatus 1400 may perform operations comprising obtaining a query and a context for the query; generating, using a language generation model, an answer token based on the query and the context; extracting a span from the context based on an attention pattern of the language generation model for generating the answer token; generating an answer to the query based on the answer token; and generating attribution information based on the extracted span, wherein the attribution information indicates a source of the answer within the context.

The memory unit 1410 may include a language generation model 1415. According to some aspects, language generation model 1415 comprises machine learning parameters stored in memory unit 1410. Language generation model 1415 is an example of, or includes aspects of, the corresponding element described with reference to FIGS. 1, 3, and 5.

In some embodiments, the language generation model 1415 is an artificial neural network (ANN), such as the transformer model described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the language generation model 1415 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1425 may train the language generation model 1415. For example, parameters of the language generation model 1415 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 12). The goal of the training process may be to find optimal values for the parameters that enable the language generation model 1415 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the language generation model 1415 can be used to make predictions on new, unseen data (i.e., during inference).

I/O module 1420 receives inputs from and transmits outputs of the data processing apparatus 1400 to other devices or users. For example, I/O module 1420 receives inputs for the language generation model 1415 and transmits outputs of the language generation model 1415. According to some aspects, I/O module 1420 is an example of the I/O interface 1320 described with reference to FIG. 13.

According to some aspects, training component 1425 comprises executable code (e.g., software) stored in memory unit 1410, firmware, one or more hardware circuits, or a combination thereof.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for data processing, comprising:
obtaining a query and a context for the query;
generating, using a language generation model, an answer token based on the query and the context;
extracting a span from the context based on an attention pattern of the language generation model for generating the answer token;
generating an answer to the query based on the answer token; and
generating attribution information based on the extracted span, wherein the attribution information indicates a source of the answer within the context.

2. The method of claim 1, wherein extracting the span comprises:
identifying a predetermined attention head from a plurality of attention heads of the language generation model, wherein the attention pattern corresponds to the predetermined attention head.

3. The method of claim 2, further comprising:
replacing an activation value of the predetermined attention head with a corrupted activation value, wherein the predetermined attention head is identified based on the replacement.

4. The method of claim 2, wherein:
the predetermined attention head comprises a node of a context-faithful circuit of the language generation model.

5. The method of claim 1, wherein extracting the span comprises:
computing an attention value corresponding to the attention pattern; and
determining that the attention value comprises a maximal attention value, wherein the span is extracted based on the determination.

6. The method of claim 1, wherein generating the answer comprises:
autoregressively generating a plurality of answer tokens based on the answer token.

7. The method of claim 1, wherein generating the attribution information comprises:
iteratively extracting a plurality of spans from the context corresponding to a plurality of answer tokens from the answer.

8. A non-transitory computer readable medium storing code for data processing, the code comprising instructions that, when executed by at least one processor, cause the at least one processor to perform operations comprising:
obtaining a probe dataset comprising a probe query and a probe context for the probe query;
computing, using an attention head of a language generation model, an activation value based on the probe query and the probe context;
replacing the activation value with a corrupted activation value;
determining that the attention head is a context-relevant attention head based on the replacement; and
generating attribution information based on an attention pattern of the attention head.

9. The non-transitory computer readable medium of claim 8, the code further comprising instructions that, when executed by the at least one processor, cause the at least one processor to perform operations comprising:
obtaining a query and a context; and
generating, using the language generation model, an answer to the query based on the context, wherein the attribution information indicates a source of the answer within the context.

10. The non-transitory computer readable medium of claim 9, the code further comprising instructions that, when executed by the at least one processor, cause the at least one processor to perform operations comprising:
generating, using the attention head, an answer token based on the query and the context;
extracting a span from the context based on the attention pattern of the attention head;
generating the answer to the query based on the answer token; and
generating the attribution information based on the extracted span.

11. The non-transitory computer readable medium of claim 10, wherein extracting the span comprises:
computing an attention value corresponding to the attention pattern; and
determining that the attention value comprises a maximal attention value, wherein the span is extracted based on the determination.

12. The non-transitory computer readable medium of claim 10, the code further comprising instructions that, when executed by the at least one processor, cause the at least one processor to perform operations comprising:
autoregressively generating a plurality of answer tokens based on the answer token.

13. The non-transitory computer readable medium of claim 9, wherein generating the attribution information comprises:
iteratively extracting a plurality of spans from the context corresponding to a plurality of answer tokens from the answer.

14. The non-transitory computer readable medium of claim 8, wherein determining that the attention head is a context-relevant attention head comprises:
identifying a context-faithful circuit of the language generation model based on the replacement; and
determining that the attention head comprises a node of the context-faithful circuit.

15. The non-transitory computer readable medium of claim 8, the code further comprising instructions that, when executed by the at least one processor, cause the at least one processor to perform operations comprising:
identifying an additional query and an additional context from the probe dataset; and
computing, using the attention head of the language generation model, the corrupted activation value based on the additional query and the additional context.

16. A system comprising:
a memory component; and
a processing device coupled to the memory component, the processing device configured to perform operations comprising:
obtaining a query and a context for the query;
generating, using a language generation model, an answer token based on the query and the context;
extracting a span from the context based on an attention pattern of the language generation model for generating the answer token;
generating an answer to the query based on the answer token; and
generating attribution information based on the extracted span, wherein the attribution information indicates a source of the answer within the context.

17. The system of claim 16, wherein:
the language generation model comprises a plurality of attention heads.

18. The system of claim 16, wherein:
the language generation model comprises a transformer model.

19. The system of claim 16, wherein extracting the span comprises:
identifying a predetermined attention head from a plurality of attention heads of the language generation model, wherein the attention pattern corresponds to the predetermined attention head.

20. The system of claim 19, the processing device being further configured to perform operations comprising:
replacing an activation value of the predetermined attention head with a corrupted activation value, wherein the predetermined attention head is identified based on the replacement.
